(19) United States
(12) Patent Application Publication
(10) Pub. No.: US 2012/0325736 A1
(43) Pub. Date: Dec. 27, 2012

(54) DIALYSIS FLUID PUMP, AND HEMODIALYSIS APPARATUS HAVING SAME

(76) Inventors: Nak-Myung Choi, Gyeonggi-do (KR); Kyungsoo Lee, Chungnam (KR); Cho Hay Mun, Seoul (KR); Sa Ram Lee, Gyeonggi-do (KR); Dong Wook Lee, Seoul (KR); Byoung-Goo Min, Gyeonggi-do (KR); Jong-Weon Choi, Seoul (KR)

(21) Appl. No.: 13/580,472

(22) PCT Filed: Jan. 17, 2011
(86) PCT No.: PCT/KR2011/000330

§ 371 Date: Sep. 5, 2012

(30) Foreign Application Priority Data
Feb. 23, 2010 (KR) 10-2010-0016093

(51) Int. Cl. B01D 61/26; F04B 43/12

(52) U.S. Cl. 210/321.72; 417/476

(57) ABSTRACT

According to the present invention, a dialyzing fluid pump comprises; a housing having an accommodating space formed therein; a dialyzing fluid supply tube and a dialyzing fluid recovery tube, at least a portion of each of which is accommodated in the accommodating space; a cam rotatably installed in the accommodation space; and a motor for rotating the cam. The dialyzing fluid supply tube is made of a flexible material which can be contracted or relaxed, and one end thereof is connected to a hemodialysis filter and the other end thereof is connected to a dialyzing fluid supply tank. The dialyzing fluid recovery tube is made of a flexible material which can be contracted or relaxed, and one end thereof is connected to the hemodialysis filter and the other end thereof is connected to a dialyzing fluid recovery tank. The cam has a cam surface for pressing the dialyzing fluid supply tube and the dialyzing fluid recovery tube so as to discharge a dialyzing fluid from the inside of the dialyzing fluid supply tube and of the dialyzing fluid recovery tube, respectively. According to the present invention, the dialyzing fluid being supplied to the hemodialysis filter is under pulsatile flow conditions, to thereby increase the magnitude of a pressure difference and the frequency of the occurrence of a pressure difference between blood and the dialyzing fluid in the hemodialysis filter.

### TECHNICAL FIELD

The present invention relates to a hemodialysis apparatus for filtering impurities contained in blood by moving blood and dialysis fluid with a hemodialysis filter interposed therebetween, and more particularly to a dialysis fluid pump and a hemodialysis apparatus having the same for supplying dialysis fluid to the hemodialysis filter.

### BACKGROUND ART

When the kidney shows partial or overall dysfunction, waste matter that would otherwise be discharged as urine from the body is accumulated in blood, and moreover electrolyte imbalance in the body occurs. As a method for correcting such kidney failure, extracorporeal circulation using a hemodialysis apparatus has been widely performed. Extracorporeal circulation using a hemodialysis apparatus is a method that removes waste matter contained in blood from the body using the principle of diffusion or filtering, and also achieves electrolyte balance.

Typically, a hemodialysis apparatus is configured to outwardly discharge impurities contained in blood using a hemodialysis filter that is equipped with a dialysis membrane within a single container to enable mass transfer through the dialysis membrane between blood and dialysis fluid. There are two kinds of hemodialysis filters including a hollow fiber membrane type hemodialysis filter and a flat sheet membrane type hemodialysis filter based on the kind of the dialysis membrane.

Among these, the hollow fiber membrane type hemodialysis filter, which is formed by loading a bundle of hollow fiber membranes into a cylindrical container, attaching resin layers to both ends of the bundle, and forming ports through the resin layers, is preferred. This is because the hollow fiber membrane type hemodialysis filter has a large contact area with blood or dialysis fluid despite a small capacity thereof, thus providing superior mass transfer efficiency.

A conventional hemodialysis apparatus includes a hemodialysis filter, a dialysis fluid supply tank for supplying clean dialysis fluid to the hemodialysis filter, a dialysis fluid recovery tank for storing dialysis fluid having passed through the hemodialysis filter, a blood pump for supplying blood to the hemodialysis filter, and a dialysis fluid pump for supplying the dialysis fluid stored in the dialysis fluid supply tank to the hemodialysis filter. The hemodialysis filter is provided with a blood inlet for inflow of blood, a blood outlet for outflow of blood, a dialysis fluid inlet for inflow of dialysis fluid, and a dialysis fluid outlet for outflow of dialysis fluid. Blood and dialysis fluid move in opposite directions within the hemodialysis filter.

Since the blood pump is located toward the blood inlet and the dialysis fluid pump is located toward the dialysis fluid inlet, blood is reduced in pressure with decreasing distance toward the blood outlet, and dialysis fluid is reduced in pressure with decreasing distance toward the dialysis fluid outlet. Diffusion of moisture, electrolyte and waste matter, for example, from blood to dialysis fluid occurs in a region where the pressure of blood is greater than the pressure of dialysis fluid, and dialysis fluid is transferred to blood in a region where the pressure of dialysis fluid is greater than the pressure of blood.

### DISCLOSURE

### Technical Problem

To enhance hemodialysis efficiency of a hemodialysis apparatus, it is necessary to provide a sufficient pressure difference between blood and dialysis fluid, or to lengthen a path where blood and dialysis fluid meet each other. However, lengthening the path where blood and dialysis fluid meet each other requires an increased size of a hemodialysis filter and consumption of a greater amount of dialysis membranes.

The present invention is devised to solve the above described problems, and it is an object of the present invention to provide a dialysis fluid pump and a hemodialysis apparatus having the same, which are capable of improving hemodialysis efficiency without requiring an increase in the size of a hemodialysis filter.

### Technical Solution

To achieve the above described object, in accordance with one embodiment of the present invention, a dialysis fluid pump includes a housing having an accommodating space therein, a dialysis fluid supply tube and a dialysis fluid recovery tube, at least a portion of each of which is accommodated in the accommodating space, a cam rotatably installed in the accommodating space, and a motor for rotating the cam. The dialysis fluid supply tube is formed of a flexible material that can be contracted and relaxed, and one end of the dialysis fluid supply tube is connected to the hemodialysis filter and the other end is connected to the dialysis fluid supply tank. The dialysis fluid recovery tube is formed of a flexible material that can be contracted and relaxed, and one end of the dialysis fluid recovery tube is connected to the hemodialysis filter and the other end is connected to the dialysis fluid recovery tank. The cam has a cam surface for pressing the dialysis fluid supply tube and the dialysis fluid recovery tube to discharge the dialysis fluid from the inside of the dialysis fluid supply tube and of the dialysis fluid recovery tube, respectively.

The dialysis fluid pump according to the embodiment of the present invention may further include a first pumping pressure member movably installed in the accommodating space so as to be pushed by the cam, wherein the first pumping pressure member includes a pressure surface adapted to press the dialysis fluid supply tube so as to discharge the dialysis fluid from the inside of the dialysis fluid supply tube, and a second pumping pressure member movably installed in the accommodating space so as to be pushed by the cam, wherein the second pumping pressure member includes a pressure surface adapted to press the dialysis fluid recovery tube so as to discharge the dialysis fluid from the inside of the dialysis fluid recovery tube.

The dialysis fluid pump according to the embodiment of the present invention may further include a plurality of elastic members connected respectively to the first pumping pressure member and the second pumping pressure member to elastically push the first pumping pressure member and the second pumping pressure member toward the cam.

The dialysis fluid pump according to the embodiment of the present invention may further include first guide means for coupling the first pumping pressure member to the housing in a sliding manner, to guide linear movement of the first pumping pressure member, and second guide means for coupling the second pumping pressure member to the housing in a sliding manner, to guide linear movement of the second pumping pressure member.

The dialysis fluid pump according to the embodiment of the present invention may further include first feed dialysis fluid backflow preventing means placed between the dialysis fluid supply tube and the hemodialysis filter for preventing the dialysis fluid supplied to the hemodialysis filter from flowing backward to the dialysis fluid supply tube, second feed dialysis fluid backflow preventing means placed between the dialysis fluid supply tube and the dialysis fluid supply tank for preventing the dialysis fluid supplied to the dialysis fluid supply tube from flowing backward to the dialysis fluid supply tank, first recovery dialysis fluid backflow preventing means placed between the dialysis fluid recovery tube and the hemodialysis filter for preventing the dialysis fluid discharged to the dialysis fluid recovery tube from flowing backward to the hemodialysis filter, and second recovery dialysis fluid backflow preventing means placed between the dialysis fluid recovery tube and the dialysis fluid recovery tank for preventing the dialysis fluid recovered to the dialysis fluid recovery tank from flowing backward to the dialysis fluid recovery tube.

The first feed dialysis fluid backflow preventing means, the second feed dialysis fluid backflow preventing means, the first recovery dialysis fluid backflow preventing means and the second recovery dialysis fluid backflow preventing means may respectively include check valves that restrict flow of fluid in a given direction.

In accordance with another embodiment of the present invention, a hemodialysis apparatus includes a hemodialysis filter to permit passage of blood and dialysis fluid therethrough, the hemodialysis filter having a dialysis membrane adapted to enable mass transfer between the blood and the dialysis fluid, a blood pump for pumping the blood to the hemodialysis filter, a dialysis fluid supply tank for storing clean dialysis fluid, a dialysis fluid recovery tank for recovering the dialysis fluid having passed through the hemodialysis filter, and a dialysis fluid pump for pumping dialysis fluid from the dialysis fluid supply tank to the hemodialysis filter and in turn from the hemodialysis filter to the dialysis fluid recovery tank. The dialysis fluid pump includes a housing having an accommodating space therein, a dialysis fluid supply tube and a dialysis fluid recovery tube, at least a portion of each of which is accommodated in the accommodating space, a cam rotatably installed in the accommodating space, and a motor for rotating the cam.

### Advantageous Effects

A dialysis fluid pump and a hemodialysis apparatus having the same according to the present invention can increase the magnitude of a pressure difference between blood and dialysis fluid and the frequency of the occurrence of the pressure difference by generating pulsating flow of dialysis fluid to be supplied to a hemodialysis filter. This has the effect of enhancing hemodialysis efficiency.

### DESCRIPTION OF DRAWINGS

FIG. 1 is a diagram view schematically illustrating a configuration of a hemodialysis apparatus according to an embodiment of the present invention.

FIG. 2 is a sectional view illustrating a hemodialysis filter of the hemodialysis apparatus according to the embodiment of the present invention.

FIG. 3 is a view illustrating a dialysis fluid pump of the hemodialysis apparatus according to the embodiment of the present invention.

FIGS. 4 and 5 are explanatory views illustrating operation of the dialysis fluid pump of the hemodialysis apparatus according to the embodiment of the present invention.

### DESCRIPTION OF REFERENCE NUMERALS

100: Hemodialysis apparatus
110: hemodialysis filter
118: blood pump 120: dialysis fluid supply tank
122: dialysis fluid recovery tank 124: balancer
130: dialysis fluid pump 131: housing
132: dialysis fluid supply tube
133: dialysis fluid recovery tube
134: first pumping pressure member
135: second pumping pressure member
136: cam
137: motor
146, 147, 148, 149: first, second, third and fourth check valves
154, 159: springs

### BEST MODE

Hereinafter, a hemodialysis apparatus according to an embodiment of the present invention will be described in detail with reference to the accompanying drawings.

In the following description of the present invention, the size, shape or the like of constituent elements illustrated in the drawings may be exaggerated or schematically illustrated for clarity and convenience of explanation. Also, the terms particularly defined taking into consideration the configurations and operations of the present invention may be changed based on intentions of users or operators and customs. These terms should be constructed as meanings and concepts conforming to the technical sprit of the present invention based on the general context of this specification.

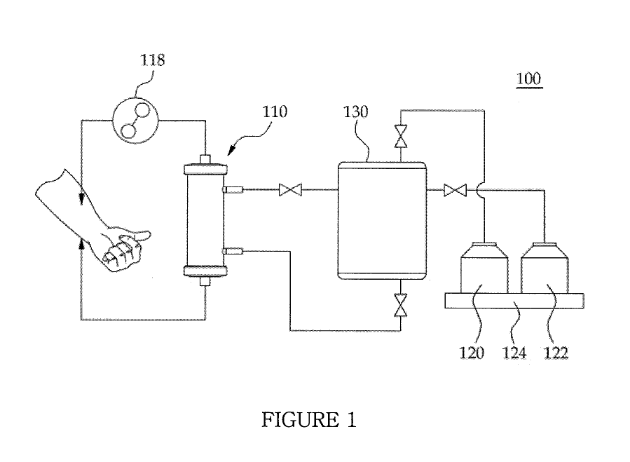

As illustrated in FIG. 1, the hemodialysis apparatus 100 according to the embodiment of the present invention includes a hemodialysis filter 110 configured to permit passage of both blood and dialysis fluid therethrough, the hemodialysis filter 110 serving to discharge impurities contained in blood along with dialysis fluid, a blood pump 118 for pumping blood of a patient to the hemodialysis filter 110, a dialysis fluid supply tank 120 for recovering clean dialysis fluid, a dialysis fluid recovery tank 122 for storing dialysis fluid having passed through the hemodialysis filter 110 therein, and a dialysis fluid pump 130 for supplying dialysis fluid to the hemodialysis filter 110 and recovering dialysis fluid of the hemodialysis filter 110. The hemodialysis filter 100, the blood pump 118, and the dialysis fluid pump 130 are connected to one another via connection pipes. In the hemodialysis apparatus 100 as described above, as mass transfer between the blood and the dialysis fluid occurs within the hemodialysis filter 110, impurities contained in the blood can be discharged outward.

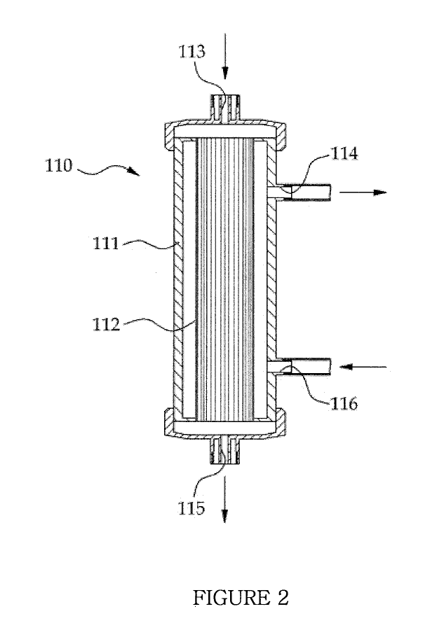

As illustrated in FIG. 2, the hemodialysis filter 110 includes a container 111 having an interior space and a dialysis membrane 112 accommodated in the interior space of the container 111. The container 111 is provided at and near an upper end thereof with a blood inlet 113 for inflow of blood and a dialysis fluid outlet 114 for outflow of dialysis fluid. Also, the container 111 is provided at and near a lower end thereof with a blood outlet 115 for outflow of blood and a dialysis fluid inlet 116 for inflow of dialysis fluid. As such, the blood flows from top to bottom and the dialysis fluid flows from bottom to top within the container 111. Within the hemodialysis filter 110, diffusion of moisture, electrolyte and waste matter from the blood to the dialysis fluid occurs in a region where the pressure of blood is greater than the pressure of dialysis fluid, and the dialysis fluid is transferred to the blood in a region where the pressure of dialysis fluid is greater than the pressure of blood.

The flow of blood is accomplished by the blood pump 118, and the supply and recovery of dialysis fluid are accomplished by the dialysis fluid pump 130 and a balancer 124. The balancer 124 controls the dialysis fluid pump 130 by comparing clean dialysis fluid to be supplied to the hemodialysis filter 110 with dialysis fluid recovered from the hemodialysis filter 110, thereby serving to regulate supply of dialysis fluid and recovery of dialysis fluid.

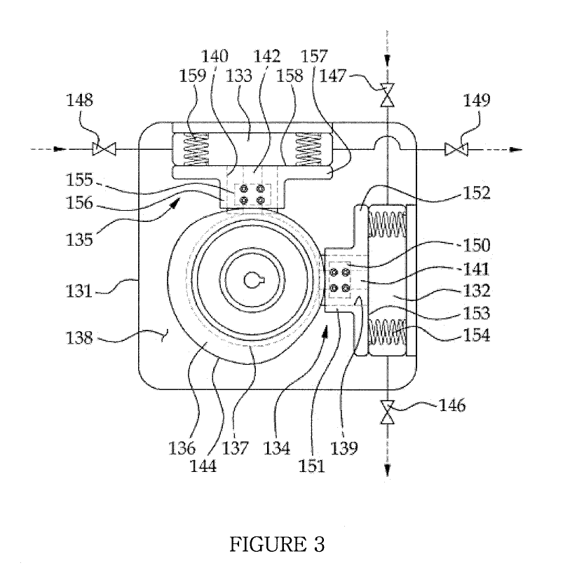

As illustrated in FIG. 3, the dialysis fluid pump 130 includes a housing 131, a dialysis fluid supply tube 132 and a dialysis fluid recovery tube 133 which are accommodated in the housing 131 and can be contracted and relaxed, a first pumping pressure member 134 for pressing the dialysis fluid supply tube 132, a second pumping pressure member 135 for pressing the dialysis fluid recovery tube 133, a cam 136 which is rotatably installed in the housing 131 and serves to actuate the first pumping pressure member 134 and the second pumping pressure member 135, and a motor 137 for rotating the cam 136.

The housing 131 has an accommodating space 138. The accommodating space 138 communicates with the outside through holes which are respectively perforated in upper and lower wall surfaces and left and right wall surfaces of the housing 131. A connection pipe for connecting the hemodialysis filter 110 and the dialysis fluid supply tube 132 to each other, a connection pipe for connecting the dialysis fluid pump 130 and the dialysis fluid supply tube 132 to each other, a connection pipe for connecting the hemodialysis filter 110 and the dialysis fluid recovery tube 133 to each other, a connection pipe for connecting the dialysis fluid recovery tank 122 and the dialysis fluid recovery tube 133 to each other may be introduced into the receiving space 138 through the holes. Also, two guide recesses 139 and 140 may be linearly indented in an inner surface of the housing 131. The guide recesses 139 and 140 are arranged at an interval of approximately 90 degrees between the rotation center of the cam 136 and the center of the dialysis fluid supply tube 132 and between the rotation center of the cam 136 and the dialysis fluid recovery tube 133. Linear guide rails 141 and 142 are respectively seated in the guide grooves 139 and 140.

The cam 136 is rotatably installed approximately at the center of the accommodating space 138. The cam 136 is provided at an outer perimeter thereof with a cam surface 144 for pressing the first pumping pressure member 134 and the second pumping pressure member 135. The motor 137 for rotating the cam 136 may be coupled to the housing 131, or may be mounted at the outside of the housing 131 so as to provide the cam 136 with rotation power.

As illustrated in FIG. 3, the dialysis fluid supply tube 132 is formed of a flexible material that can be contracted or relaxed. One end of the dialysis fluid supply tube 132 is connected to the hemodialysis filter 110 through the corresponding connection pipe, and the other end of the dialysis fluid supply tube 132 is connected to the dialysis fluid supply tank 120 through the corresponding connection pipe. A first check valve 146 is provided at the connection pipe that connects the dialysis fluid supply tube 132 and the hemodialysis filter 110 to each other, and a second check valve 147 is provided at the connection pipe that connects the dialysis fluid supply tube 132 and the dialysis fluid supply tank 120 to each other. The first check valve 146 serves as first feed dialysis fluid backflow preventing means for preventing the dialysis fluid supplied to the hemodialysis filter 110 from flowing backward to the dialysis fluid supply tube 132. Also, the second check valve 147 serves as second feed dialysis fluid backflow preventing means for preventing the dialysis fluid supplied to the dialysis fluid supply tube 132 from flowing backward to the dialysis fluid supply tank 120.

Instead of the check valves that restrict flow of fluid in a given direction, other various devices capable of restricting flow of dialysis fluid in a given direction through the dialysis fluid supply tube 132 may be used as the first feed dialysis fluid backflow preventing means and the second feed dialysis fluid backflow preventing means. For example, instead of the first check valve 146 or the second check valve 147, there may be provided devices capable of pressing the connection pipe between the dialysis fluid supply tube 132 and the hemodialysis filter 110 and the connection pipe between the dialysis fluid supply tube 132 and the dialysis fluid supply tank 120 so as to restrict flow of dialysis fluid through the respective connection pipes.

When the first pumping pressure member 134 applies pressure to the dialysis fluid supply tube 132, the dialysis fluid supply tube 132 is pressed, causing discharge of the dialysis fluid from the inside of the dialysis fluid supply tube 132 to the hemodialysis filter 110. Once the pressure applied by the first pumping pressure member 134 is removed, the dialysis fluid supply tube 132 is elastically restored to an original state. While the dialysis fluid supply tube 132 expands to an original state thereof, the dialysis fluid stored in the dialysis fluid supply tank 120 is suctioned into the dialysis fluid supply tube 132. The dialysis fluid supply tube 132 may be formed of various materials, such as rubber, silicone and resin, for example, that can be contracted upon receiving pressure, and then can be elastically restored to an original state thereof upon removal of the pressure.

As illustrated in FIG. 3, the dialysis fluid recovery tube 133 is formed of a flexible material that can be contracted or relaxed. One end of the dialysis fluid recovery tube 133 is connected to the hemodialysis filter 110 through the corresponding connection pipe, and the other end of the dialysis fluid recovery tube 133 is connected to the dialysis fluid recovery tank 122 through the corresponding connection pipe. A third check valve 148 is provided at the connection pipe that connects the dialysis fluid recovery tube 133 and the hemodialysis filter 110 to each other. The third check valve 148 serves as first recovery dialysis fluid backflow preventing means for preventing the dialysis fluid discharged to the dialysis fluid recovery tube 133 from flowing backward to the hemodialysis filter 110. Also, a fourth check valve 149 is provided at the connection pipe that connects the dialysis fluid recovery tube 133 and the dialysis fluid recovery tank 122 to each other. The fourth check valve 149 serves as second recovery dialysis fluid backflow preventing means for preventing the dialysis fluid recovered to the dialysis fluid recovery tank 122 from flowing backward to the dialysis fluid recovery tube 133.

Instead of the check valves, other various devices capable of restricting flow of dialysis fluid in a given direction through the dialysis fluid recovery tube 133 may be used as the first recovery dialysis fluid backflow preventing means and the second recovery dialysis fluid backflow preventing means. For example, instead of the third check valve 148 or the fourth check valve 149, there may be provided devices capable of pressing the connection pipe between the dialysis fluid recovery tube 133 and the hemodialysis filter 110 and the connection pipe between the dialysis fluid recovery tube 133 and the dialysis fluid recovery tank 122 so as to restrict flow of dialysis fluid through the respective connection pipes.

When the second pumping pressure member 135 applies pressure to the dialysis fluid recovery tube 133, the dialysis fluid recovery tube 133 is pressed, causing discharge of the dialysis fluid from the inside of the dialysis fluid recovery tube 133 to the dialysis fluid recovery tank 122. Once the pressure applied by the second pumping pressure member 135 is removed, the dialysis fluid recovery tube 133 is elastically restored to an original state. While the dialysis fluid recovery tube 133 expands to an original state thereof, the dialysis fluid stored in the hemodialysis filter 110 is suctioned into the dialysis fluid recovery tube 133.

As illustrated in FIG. 3, the first pumping pressure member 134 serves to enable discharge of the dialysis fluid from the inside of the dialysis fluid supply tube 132 to the hemodialysis filter 110, and is fitted into the guide groove 139 of the housing 131 in a sliding manner. The first pumping pressure member 134 includes a sliding portion 151 having a slider 150 that is coupled to the guide rail 141 inside the guide groove 139 in a sliding manner, and a pressure portion 152 connected to the sliding portion 151 so as to apply pressure to the dialysis fluid supply tube 132 accommodated in the accommodating space 140. The pressure portion 152 is provided at a distal end thereof with a pressure surface 153 that comes into contact with the dialysis fluid supply tube 132.

The guide rail 141 and the slider 150 constitute first guide means for coupling the first pumping pressure member 134 to the housing 131 in a sliding manner. Instead of the illustrated configuration, the first guide means may be replaced by other structures capable of guiding linear movement of the first pumping pressure member 134, such as linear elongated grooves or rails, for example.

To enhance the supply efficiency of the dialysis fluid, it is necessary to increase the amount of dialysis fluid to be discharged at a time by increasing the press area of the dialysis fluid supply tube 132. To this end, the pressure portion 152 has a possible maximum size under conditions of not interfering with the remaining region of the accommodating space 138. The pressure surface 153 may advantageously be a flat surface or a concavely curved surface in terms of increase in the press magnitude of the dialysis fluid supply tube 132.

If the cam surface 144 applies pressure to a distal end of the sliding portion 151, the first pumping pressure member 134 slides toward the dialysis fluid supply tube 132 along the guide recess 139, thereby pressing the dialysis fluid supply tube 132. Low friction members may be coupled to the distal end of the sliding portion 151 of the first pumping pressure member 134, in order to reduce wear due to contact with the cam surface 144.

The first pumping pressure member 134 is elastically forced away from the dialysis fluid supply tube 132 by a plurality of springs 154. Once pressure is removed by the cam 136, the first pumping pressure member 134 is moved to an original position thereof by elasticity of the dialysis fluid supply tube 132 and elasticity of the plurality of springs 154. The springs 154 assist the first pumping pressure member 134 in returning to an original position thereof, enabling more rapid elastic restoration of the dialysis fluid supply tube 132. Of course, the springs 154 may be omitted. In this case, the dialysis fluid supply tube 132 may expand to an original state thereof by elastically pushing the first pumping pressure member 134.

The second pumping pressure member 135 serves to enable discharge of the dialysis fluid from the inside of the dialysis fluid recovery tube 133 to the dialysis fluid recovery tank 122, and is fitted into the guide groove 140 of the housing 131 in a sliding manner. The first pumping pressure member 134 includes a sliding portion 156 having a slider 155 that is coupled to the guide rail 142 inside the guide groove 140 in a sliding manner, and a pressure portion 157 connected to the sliding portion 156 so as to apply pressure to the dialysis fluid supply tube 132 and the sliding portion 156.

The guide rail 142 and the slider 155 constitute second guide means for coupling the second pumping pressure member 134 to the housing 131 in a sliding manner. Instead of the illustrated configuration, the second guide means may be replaced by other structures capable of guiding linear movement of the second pumping pressure member 134, such as linear elongated grooves or rails, for example.

A pressure surface 158 is provided at a distal end of the pressure portion 157 that comes into contact with the dialysis fluid supply tube 132. The second pumping pressure member 135 is elastically forced so as to move away from the dialysis fluid recovery tube 133 by a plurality of springs 159. A detailed configuration of the second pumping pressure member 135 is equal to that of the above described first pumping pressure member 134, and thus a detailed description thereof will be omitted hereinafter.

Hereinafter, operation of the dialysis fluid pump 130 according to the embodiment of the present invention will be described with reference to the accompanying drawings.

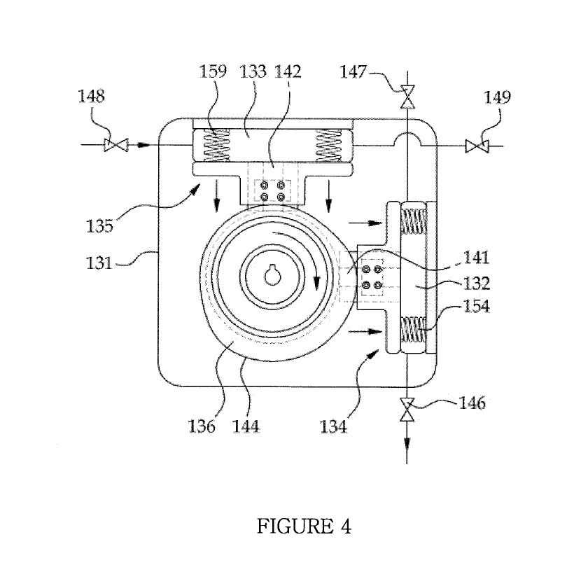

As illustrated in FIG. 4, if pressure is applied to the first pumping pressure member 134 via rotation of the cam 136 and pressure applied to the second pumping pressure member 135 is removed, external force is applied to the first pumping pressure member 134 to move the first pumping pressure member 134 toward the dialysis fluid supply tube 132 and is also applied to the second pumping pressure member 135 to move the second pumping pressure member 135 toward the cam 136. In this case, the first pumping pressure member 134 causes the dialysis fluid supply tube 132 to be pressed by elasticity of the springs 154. The second pumping pressure member 135 is pushed toward the cam 136 upon receiving elasticity of the springs 159 and the dialysis fluid recovery tube 133, and the dialysis fluid recovery tube 133 expands to an original state thereof.

Once the dialysis fluid supply tube 132 has been pressed, the dialysis fluid is pumped from the inside of the dialysis fluid supply tube 132 to the hemodialysis filter 110. In this case, the second check valve 147 acts to prevent the dialysis fluid inside the dialysis fluid supply tube 132 from flowing backward to the dialysis fluid supply tank 120 while allowing the dialysis fluid to flow only toward the hemodialysis filter 110. Also, once the dialysis fluid recovery tube 133 has expanded, the interior pressure of the dialysis fluid recovery tube 133 is lowered, which causes the dialysis fluid to be suctioned from the hemodialysis filter 110 to the dialysis fluid recovery tube 133. In this case, the fourth check valve 149 acts to prevent the dialysis fluid inside the dialysis fluid recovery tank 122 from flowing backward to the dialysis fluid recovery tube 133.

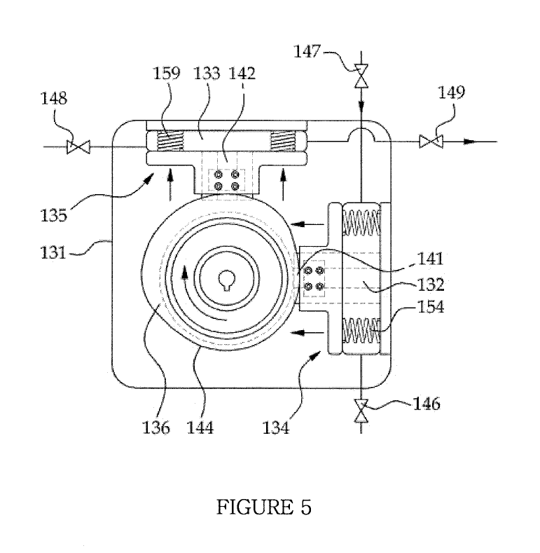

As illustrated in FIG. 5, if pressure applied to the first pumping pressure member 134 via rotation of the cam 136 is removed and pressure is applied to the second pumping pressure member 135, the first pumping pressure member 134 is pushed toward the cam 136 by elasticity of the dialysis fluid supply tube 132 and the springs 154. Also, the second pumping pressure member 135 causes the dialysis fluid recovery tube 133 to be pressed by elasticity of the springs 159.

Once the dialysis fluid supply tube 132 has expanded, the interior pressure of the dialysis fluid supply tube 132 is lowered, which causes the dialysis fluid to be suctioned from the inside of the dialysis fluid supply tank 120 to the dialysis fluid supply tube 132. In this case, the first check valve 146 acts to prevent the dialysis fluid supplied to the hemodialysis filter 110 from flowing backward to the dialysis fluid supply tube 132.

Also, once the dialysis fluid recovery tube 133 has been pressed, the dialysis fluid is pumped from the inside of the dialysis fluid recovery tube 133 to the dialysis fluid recovery tank 122. In this case, the third check valve 148 acts to prevent the dialysis fluid inside the dialysis fluid recovery tube 133 from flowing backward to the hemodialysis filter 110 while allowing the dialysis fluid to flow only toward the dialysis fluid recovery tank 122.

In this way, the dialysis fluid pump 130 according to the embodiment of the present invention may increase the magnitude of a pressure difference between the blood and the dialysis fluid and the frequency of the occurrence of the pressure difference by generating pulsating flow of the dialysis fluid to be supplied to the hemodialysis filter 110. In this way, enhanced hemodialysis efficiency may be accomplished.

In the present invention, the dialysis fluid supply tube 132 or the dialysis fluid recovery tube 133 may be directly pressed by the cam 136 with omission of the first pumping pressure member 134 or the second pumping pressure member 135. In this case, to prevent wear and damage to the dialysis fluid supply tube 132 or the dialysis fluid recovery tube 133 due to contact with the cam surface 144, a reinforcing member may be coupled to an outer surface of the dialysis fluid supply tube 132 or the dialysis fluid recovery tube 133 so as to come into contact with the cam surface 144. The plurality of springs 154 and 159, which are used to elastically push the first pumping pressure member 134 and the second pumping pressure member 135, may be replaced by various other elastic members.

Although a method of utilizing the dialysis fluid pump 130 as a blood supply pump may be contemplated, this is undesirable because pulsation of blood to be supplied to the hemodialysis filter 110 may cause destruction of matters contained in blood, which may result in cythemolysis, destruction of red corpuscles, and blood clot, for example.

The embodiment of the present invention described above and illustrated in the drawings should not be construed as limiting the technical spirit of the present invention. The scope of the present invention should be defined as disclosed in the accompanying claims, and those skilled in the art will appreciate that various modifications, additions and substitutions are possible without departing from the scope and spirit of the invention.

1. A dialysis fluid pump for pumping dialysis fluid from a dialysis fluid supply tank to a hemodialysis filter and in turn from the hemodialysis filter to a dialysis fluid recovery tank, the dialysis fluid pump comprising:
a housing having an accommodating space therein;
a dialysis fluid supply tube formed of a flexible material that can be contracted and relaxed, wherein at least a portion of the dialysis fluid supply tube is accommodated in the accommodating space, and one end of the dialysis fluid supply tube is connected to the hemodialysis filter and the other end is connected to the dialysis fluid supply tank;
a dialysis fluid recovery tube formed of a flexible material that can be contracted and relaxed, wherein at least a portion of the dialysis fluid recovery tube is accommodated in the accommodating space, and one end of the dialysis fluid recovery tube is connected to the hemodialysis filter and the other end is connected to the dialysis fluid recovery tank;
a cam rotatably installed in the accommodating space, wherein the cam has a cam surface for pressing the dialysis fluid supply tube and the dialysis fluid recovery tube to discharge the dialysis fluid from the inside of the dialysis fluid supply tube and of the dialysis fluid recovery tube, respectively; and
a motor for rotating the cam.

2. The dialysis fluid pump according to claim 1, further comprising:
a first pumping pressure member movably installed in the accommodating space so as to be pushed by the cam, wherein the first pumping pressure member includes a pressure surface adapted to press the dialysis fluid supply tube so as to discharge the dialysis fluid from the inside of the dialysis fluid supply tube; and
a second pumping pressure member movably installed in the accommodating space so as to be pushed by the cam, wherein the second pumping pressure member includes a pressure surface adapted to press the dialysis fluid recovery tube so as to discharge the dialysis fluid from the inside of the dialysis fluid recovery tube.

3. The dialysis fluid pump according to claim 2, further comprising a plurality of elastic members connected respectively to the first pumping pressure member and the second pumping pressure member to elastically push the first pumping pressure member and the second pumping pressure member toward the cam.

4. The dialysis fluid pump according to claim 2, further comprising:
first guide means for coupling the first pumping pressure member to the housing in a sliding manner, to guide linear movement of the first pumping pressure member; and
second guide means for coupling the second pumping pressure member to the housing in a sliding manner, to guide linear movement of the second pumping pressure member.

5. The dialysis fluid pump according to claim 1, further comprising:
first feed dialysis fluid backflow preventing means placed between the dialysis fluid supply tube and the hemodialysis filter for preventing the dialysis fluid supplied to the hemodialysis filter from flowing backward to the dialysis fluid supply tube;
second feed dialysis fluid backflow preventing means placed between the dialysis fluid supply tube and the dialysis fluid supply tank for preventing the dialysis fluid supplied to the dialysis fluid supply tube from flowing backward to the dialysis fluid supply tank;
first recovery dialysis fluid backflow preventing means placed between the dialysis fluid recovery tube and the hemodialysis filter for preventing the dialysis fluid discharged to the dialysis fluid recovery tube from flowing backward to the hemodialysis filter; and
second recovery dialysis fluid backflow preventing means placed between the dialysis fluid recovery tube and the dialysis fluid recovery tank for preventing the dialysis fluid recovered to the dialysis fluid recovery tank from flowing backward to the dialysis fluid recovery tube.

6. The dialysis fluid pump according to claim 5, wherein the first feed dialysis fluid backflow preventing means, the second feed dialysis fluid backflow preventing means, the first recovery dialysis fluid backflow preventing means and the second recovery dialysis fluid backflow preventing means respectively include check valves that restrict flow of fluid in a given direction.

7. A hemodialysis apparatus comprising:
a hemodialysis filter to permit passage of blood and dialysis fluid therethrough, wherein the hemodialysis filter includes a dialysis membrane adapted to enable mass transfer between the blood and the dialysis fluid;
a blood pump for pumping the blood to the hemodialysis filter;
a dialysis fluid supply tank for storing clean dialysis fluid;
a dialysis fluid recovery tank for recovering the dialysis fluid having passed through the hemodialysis filter; and
a dialysis fluid pump for pumping dialysis fluid from the dialysis fluid supply tank to the hemodialysis filter and in turn from the hemodialysis filter to the dialysis fluid recovery tank,
wherein the dialysis fluid pump includes:
a housing having an accommodating space therein;
a dialysis fluid supply tube formed of a flexible material that can be contracted and relaxed, wherein at least a portion of the dialysis fluid supply tube is accommodated in the accommodating space, and one end of the dialysis fluid supply tube is connected to the dialysis fluid supply tank and the other end is connected to the hemodialysis filter;
a dialysis fluid recovery tube formed of a flexible material that can be contracted and relaxed, wherein at least a portion of the dialysis fluid recovery tube is accommodated in the accommodating space, and one end of the dialysis fluid recovery tube is connected to the dialysis fluid recovery tank and the other end is connected to the hemodialysis filter;
a cam rotatably installed in the accommodating space, wherein the cam has a cam surface for pressing the dialysis fluid supply tube and the dialysis fluid recovery tube to discharge the dialysis fluid from the inside of the dialysis fluid supply tube and of the dialysis fluid recovery tube, respectively; and
a motor for rotating the cam.
